(19) United States
(12) Patent Application Publication
(10) Pub. No.: US 2015/0097383 A1
(43) Pub. Date: Apr. 9, 2015

(54) SAFETY LATCH

(71) Applicant: Cargo Protectors, Inc., St. Cloud, MN (US)

(72) Inventors: Kirk Busse, St. Cloud, MN (US); John Roland, Sartell, MN (US); Greg Robbins, Hutchinson, MN (US)

(21) Appl. No.: 14/502,619

(22) Filed: Sep. 30, 2014

Related U.S. Application Data
(60) Provisional application No. 61/886,379, filed on Oct. 3, 2013.

(51) Int. Cl. E05C 19/18

(52) U.S. Cl. CPC E05C 19/182
USPC 292/289

(57) ABSTRACT

A safety latch including a track channel and a slider plate. The track channel is structured to be secured adjacent a face plate of a latch bolt assembly of a door and to support the slider plate. The track channel presents a first latch bolt opening. The first latch bolt opening is sized and positioned such that when the track channel is secured to the face plate a latch bolt of the latch bolt assembly can be extended and retracted through the first latch bolt opening. The slider plate presents a second latch bolt opening and being is shiftable relative to the track channel between a first position in which the second latch bolt opening is aligned with the first latch bolt opening and a second position wherein the latch bolt is held retracted behind the slider plate.

### RELATED APPLICATION

This application claims the benefit of U.S. Provisional Application No. 61/886,379, filed Oct. 3, 2013, which is incorporated herein in its entirety by reference.

### FIELD OF THE INVENTION

The invention generally relates to the field of door locks. More particularly the invention relates to door locks having a spring biased latch bolt that engages a strike plate.

### BACKGROUND OF THE INVENTION

Recent tragic school and workplace events of violence have caused those responsible for safety and security to place increased emphasis in “lock down” procedures. These procedures often require teachers or managerial personnel to attempt to separate possible victims of violence from potential perpetrators. This is often done by sequestering would-be victims into office spaces or school rooms and locking the door for shelter.

Many existing commercial door latches used in schools and workplaces can only be locked from the outside. Generally, these require the engagement of a key into a lock that is located on or in an exterior knob. While this is useful to reduce the likelihood of accidental or mischievous locking of doors when it is not desired, it presents a problem in the event of an emergency. In an emergency situation where a lockdown is instituted, teachers or managerial personnel are forced to put themselves at risk of harm by leaving the relative safety of the classroom or office to stand in the hall to lock the door. Due to the aforementioned, there is a need for improvement of the door latches and lock mechanisms frequently used in these institutions. Moreover, the ability to quickly secure a door lock without having to exit the safety of a closed room is of significant importance.

Door locks used in these circumstances often include a latch bolt assembly. A latch bolt assembly generally includes a latch bolt engaged to a spring in a housing where the spring is positioned and oriented to bias the latch bolt outwardly through a latch bolt face plate. The latch bolt face plate generally is secured the door by two screws while the housing is located within a bore hole in the door. The latch bolt is retractable against the spring bias by manipulating the knob or handle of the latch and lock assembly. When the latch bolt assembly is attached to a door and a strike plate to the door jamb, the latch bolt is generally oriented to protrude into an opening in the strike plate when the door is closed thus securing the door in a closed position.

### SUMMARY OF THE INVENTION

Embodiments of the invention address the above problems.

Embodiments of the invention generally include a safety latch including a track channel and a slider plate. The track channel is structured to house the slider plate in slidable relation. The track channel is thin enough to be installed on the door latch overlying the latch bolt face plate and is secured by the latch bolt face plate screws with the latch bolt aligned to pass through a latch bolt opening in the track channel while still allowing the door to close with the safety latch located between the door and the strike plate located in the jamb.

The slider plate has at least two opening. One opening is for the latch bolt to pass through and one opening is for screw access. The Safety latch is installed as depicted and described in the appendix attached. When it is desired to have the door unlocked the latch bolt is retracted and the slider plate is positioned to hold the latch bolt retracted. The door lock mechanism is left in a locked status and the door may be passed through as desired. When a lock down situation occurs the teacher or managerial person need only open the door slightly and raise the slider plate to release the latch bolt and close the door to lock the door. There is no necessity to enter the hall to lock the door.

### BRIEF DESCRIPTION OF THE DRAWINGS

FIG. 1 is a perspective view of a safety latch according to an example embodiment of the invention;

FIG. 2 is a front elevational view of a safety latch according to an example embodiment of the invention;

FIG. 3 is a rear elevational view of a safety latch according to an example embodiment of the invention;

FIG. 4 is a perspective view of a slider plate according to an example embodiment of the invention;

FIG. 5 is a perspective view of a track channel according to an example embodiment of the invention; and

FIG. 6 is a front elevational view of a safety latch installed on a door according to an example embodiment of the invention.

### DETAILED DESCRIPTION

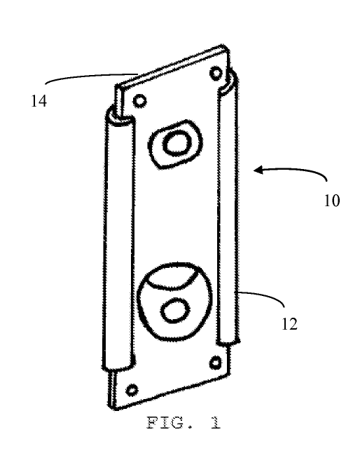

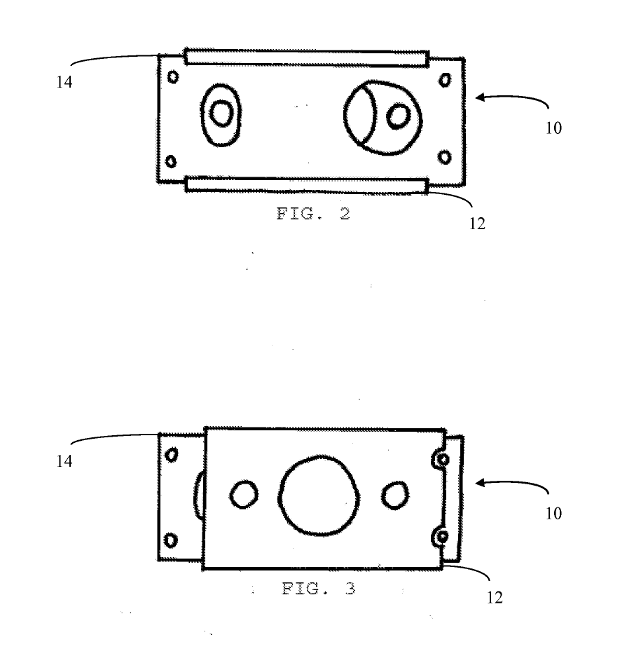

A safety latch 10 of the present invention generally includes a track channel 12 and a slider plate 14. Referring to FIGS. 1-3 slider plate 14 is slidably engaged within track channel 12 being confined from side to side motion and is therefore, slidable in an up or down motion.

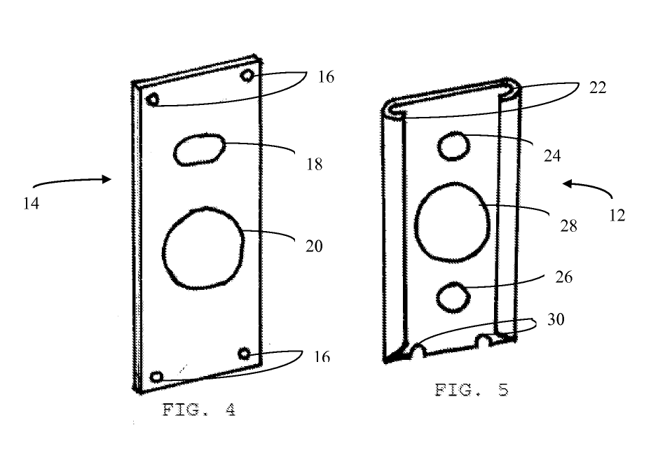

Referring to FIG. 3-4, slider plate 14 is a generally planar structure having a front face 16, a rear face 18 and a relatively thin cross-section. According to an example embodiment, slider plate 14 is approximately three times greater in length than width and can be manufactured for example, from machined metal, stamped sheet metal, molded composite or any other similar strength material having sufficient rigidity.

According to an example embodiment, slider plate 14 includes four protruding stop tab portions 20. Stop tabs may be circularly shaped, for example. Stop tab portions 20 extend generally outwardly from rear face 18 with a corresponding circular shaped indent into front face 16. Stop tab portions 20 are positioned proximate each of the four corners of the plate.

According to an example embodiment, slider plate 14 further presents at least two openings including screw access opening 22 and latch bolt access opening 24. The screw access opening 22 may be oblong or circular in shape and extends completely through the slider plate 14. The latch bolt access opening 24 may include a circular, rectangular or square shape to accommodate the plurality of latch bolt shapes available and extends completely through the slider plate 14. The location of the screw access opening 22 and latch bolt access opening 24 are such that they can be aligned to first screw opening 28 and second screw opening 30 of track channel 12 providing access thereto when slider plate 14 and track channel 12 are combined with rear face 16 facing inside face 36.

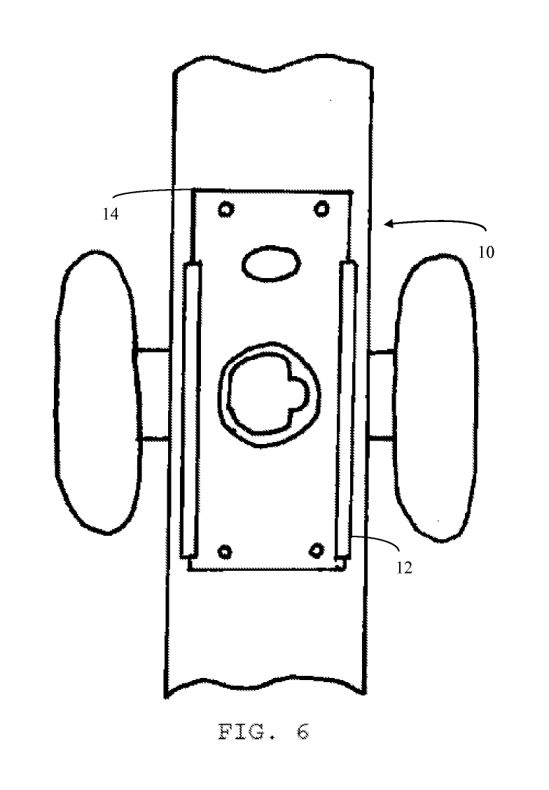

Referring to FIG. 3-5, track channel 12 includes a generally planar portion 35 with an inside face 36 and an outside face 38, and includes U-channel portions 26 along the outer edges 39 of the length of the track which open inwardly towards the center of the track channel 12. The U-channel portions 26 are shaped such that they can receive the slider plate 14 therein and allow free sliding motion. The U-channel portions 26 extend inwardly enough to prevent the slider plate 14 from being released and as such hold the slider plate 14 in generally parallel relation to the track channel 12. Track channel 12 has a length approximately twice its width and can be manufactured of machined metal, stamped sheet metal, molded composite or any other similar strength material. The track channel 12 may present at least three openings, first screw opening 28, second screw opening 30, and latch bolt opening 32. The track channel 12 may also present at least two stop tab receiving notches 34 located on the width edge closest to the second screw opening 30 and spaced apart such that they can receive stop tabs 20 therein when slider plate 14 and track channel 12 are coupled together. When combined, slider plate 14 is received within U-channels 26 of track channel 12 with rear face 18 directly opposite inside face 36.

The screw access opening 22 and the latch bolt opening 24 are positioned relative to each other such that when the screw access opening 22 is aligned with first screw opening 28 the latch bolt opening 32 is aligned with the second screw opening 30.

An embodiment of the invention also includes a method of securing and releasing a door including opening the door at least partially while maintaining or putting the latch bolt lock into a locked status; releasing the door by manually depressing the latch bolt through a latch bolt access opening 24 in the slider plate. The method further includes moving the slider plate 14 in a first direction in track channel 12 such that the latch bolt access opening 24 is shifted relative to the latch bolt such that the latch bolt is held behind the slider plate 14 whereby the latch bolt is inhibited from engaging a strike plate. The method then includes securing the door by sliding the slider plate 14 in a second direction opposed to the first direction such that the latch bolt access opening 24 is aligned with the latch bolt and the latch bolt is released and extended outwardly through the latch bolt access opening 24 whereby the latch bolt is engageable with the strike plate and the door is secured in a closed orientation when the door is closed by engagement of the latch bolt with the strike plate.

According to another embodiment the method includes attaching the track channel 12 to a face plate of a latch bolt assembly of which the latch bolt is a part.

According to another embodiment the method includes aligning the track channel 12 with the face plate of the latch bolt assembly such that a first set of fastener openings 28, 30 in the track channel 12 align with a second set of fastener openings in the face plate and inserting fasteners through the first set of fastener openings 28, 30 into the second set of fastener openings.

According to another embodiment the method includes shifting the slider plate 14 to a position wherein a first of the second set of fastener openings 28, 30 is aligned with and accessible through screw access opening 22 and a second of the second set of fastener openings 28, 30 is aligned with and accessible through the latch bolt access opening 24.

In operation, the safety latch 10 is installed on an existing door latch overlying the latch bolt assembly. For installation screws that secure the latch bolt faceplate of the door are removed from the face plate and safety latch 10 is positioned overlying the face plate such that when the safety latch 10 is installed on an existing door the slider plate 14 location of the screw access opening 22 and latch bolt access opening 24 are such that access to a first screw opening 28 and second screw opening 30 of track channel 12 are available. When 22, 24, 28 and 30 are positioned they allow access to the existing latch bolt assembly attachment screw holes.

1. A safety latch comprising:
a track channel; and
a slider plate;
the track channel being structured to be secured adjacent and overlying a face plate of a latch bolt assembly of a door and to support the slider plate in slidable relation to the track channel, the track channel presenting a first latch bolt opening therethrough, the first latch bolt opening being sized and positioned such that when the track channel is secured to the face plate a latch bolt of the latch bolt assembly can be extended and retracted through the first latch bolt opening;
the slider plate presenting a second latch bolt opening therethrough and being shiftable relative to the track channel between a first position in which the second latch bolt opening is aligned with the first latch bolt opening such that the latch bolt can be extended through both the first latch bolt opening and the second latch bolt opening and outwardly from the face plate to engage a strike plate and a second position wherein the latch bolt is held retracted behind the slider plate.

2. The safety latch as claimed in claim 1 wherein the slider plate further defines a screw access opening therethrough.

3. The safety latch as claimed in claim 2, wherein the track channel further defines two screw holes therethrough and wherein the screw access opening and the second latch bolt opening are positioned relative to each other such that when the screw access opening is aligned with one of the screw holes the second latch bolt opening is aligned with the other of screw holes whereby the two screw holes are simultaneously accessible.

4. The safety latch as claimed in claim 3, wherein the two screw holes are surrounded by a frustoconical portion.

5. The safety latch as claimed in claim 1, wherein the track channel further presents a first u-channel portion and a second opposed u-channel portion, the first u channel portion and the second u channel portion being inwardly facing and spaced part to receive the slider plate therein and therebetween.

6. The safety latch as claimed in claim 1, wherein the slider plate further comprises at least one stop tab engageable to the track channel extending outwardly from a first face thereof.

7. The safety latch as claimed in claim 1, wherein the track channel together with the slider plate is sufficiently thin so as to fit between a closed door and a related door jamb.

8. The safety latch as claimed in claim 6, wherein the track channel further presents at least one stop tab receiving notch sized, positioned and oriented to receive the at least one stop tab therein.

9. A method of releasing and securing a door comprising:
opening the door at least partially;
maintaining or putting the latch bolt lock into a locked status;
inhibiting the latch bolt of the door from engaging a strike plate by manually depressing the latch bolt through a latch bolt opening in a slider plate and moving the slider plate in a first direction in a track channel such that the latch bolt opening is shifted relative to the latch bolt such that the latch bolt is held behind the slider plate whereby the latch bolt is inhibited from engaging the strike plate; and
releasing the latch bolt and securing the door by shifting the slider plate in a second direction opposed to the first direction such that the latch bolt opening is aligned with the latch bolt and the latch bolt is released and extended outwardly through the latch bolt opening whereby the latch bolt is engageable with the strike plate and the door is secured in a closed orientation by engagement of the latch bolt with the strike plate when the door is closed.

10. The method as claimed in claim 9, further comprising attaching the track channel to a face plate of a latch bolt assembly of which the latch bolt is a part.

11. The method as claimed in claim 10, further comprising aligning the track channel with the face plate of the latch bolt assembly such that a first set of fastener openings in the track channel align with a second set of fastener openings in the face plate and inserting fasteners through the first set of fastener openings into the second set of fastener openings.

12. The method as claimed in claim 11, further comprising shifting the slider plate to a position wherein a first of the second set of fastener openings is aligned with and accessible through a screw access opening and a second of the second set of fastener openings is aligned with and accessible through the latch bolt opening.
